(19) United States
(12) Patent Application Publication
(10) Pub. No.: US 2004/0022209 A1
(43) Pub. Date: Feb. 5, 2004

(54) Voice call precedence over active packet data call

(76) Inventors: Pravati Misra, San Ramon, CA (US); David Albert Rossetti, Randolph, NJ (US); Patrick Jay Walsh, Bloomingdale, IL (US); Shawn S. Yu, Naperville, IL (US)

Correspondence Address: Docket Administrator (Room 3J-219), Lucent Technologies Inc., 101 Crawfords Corner Road, Holmdel, NJ, 07733-3030, US

(21) Appl. No.: 10/212,553

(22) Filed: Aug. 5, 2002

(51) Int. Cl. H04Q 7/00; H04L 12/28

(52) U.S. Cl. 370/328; 370/292

(57) ABSTRACT

A Voice call Precedence Over Packet Data (VPOPD) technique which would allow a customer of a wireless communication network service provider to choose whether to receive a call during an active packet data session. The VPOPD technique is a method of call processing comprising the steps of setting a feature value to be used in call processing when an associated mobile station has an active packet data session, and determining whether to reject a call termination request for the mobile station when the mobile station has an active packet data session using the feature value. The feature value may be set using a feature code transmitted from the mobile station, or provided by a service provider. If a determination to accept the call termination request is made, the following additional steps are performed: a message is sent to the mobile station to prevent race conditions from occurring, the mobile station is caused to enter a dormant state, and then the mobile is paged.

### FIELD OF THE INVENTION

The present invention relates generally to wireless communication networks and, in particular, to packet data transmission in wireless communication networks.

### BACKGROUND OF THE RELATED ART

In second and third generation wireless communication networks, data services are being offered to customers with properly equipped mobile stations. Such customers ma obtain data services by first obtaining a data traffic channel, such as a fundamental channel, from the wireless communication network, and then entering into a packet data session (which includes a plurality of data calls) where packets of data are transmitted from the wireless communication network to the mobile station. While a mobile station is in an active packet data session, the wireless communication network may automatically reject any incoming voice call attempt to the mobile station. In some instances, automatically rejecting incoming voice call attempts when a mobile station is in an active packet data session is undesirable, particularly when the voice call is an important call. Accordingly, there exists a need to a customer of a wireless communication network service provider to choose whether to receive a call during an active packet data session.

### SUMMARY OF THE INVENTION

The present invention is a Voice call Precedence Over Packet Data (VPOPD) technique which would allow a customer of a wireless communication network service provider to choose whether to receive a call during an active packet data session. The VPOPD technique is incorporated as a call processing feature in wireless communication networks. In one embodiment, the VPOPD technique is a method of call processing in a wireless communication network comprising the steps of setting a feature value to be used in call processing when an associated mobile station has an active packet data session, and determining whether to reject a call termination request for the mobile station when the mobile station has an active packet data session using the feature value. The feature value may be set using a feature code transmitted from the mobile station or provided by a service provider. If there is a determination to accept the call termination request, the following additional steps are performed: a message is sent to the mobile station to prevent race conditions from occurring, the mobile station is caused to enter a dormant state, and then the mobile is paged.

### BRIEF DESCRIPTION OF THE DRAWINGS

The features, aspects, and advantages of the present invention will become better understood with regard to the following description, appended claims, and accompanying drawings where:

FIG. 1 depicts a wireless communication network used in accordance with the present invention;

FIG. 2 depicts a flowchart illustrating the Voice call Precedence Over Packet Data (VPOPD) technique in accordance with one embodiment of the present invention; and

FIG. 3 depicts a table illustrating four basic types of VPOPD feature codes.

### DETAILED DESCRIPTION

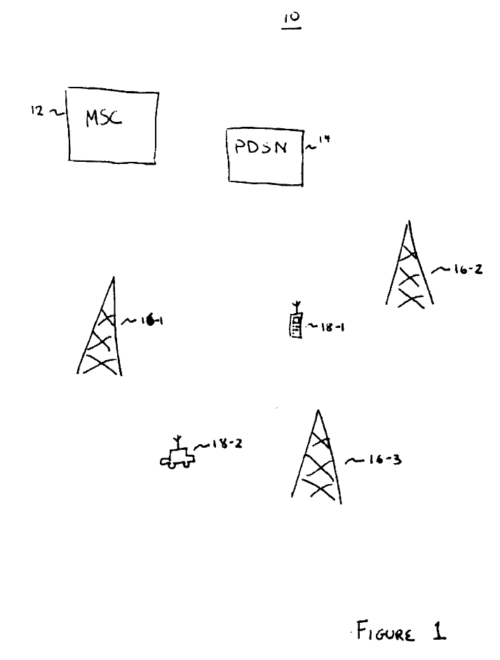

FIG. 1 depicts a wireless communication network 10 used in accordance with the present invention. Wireless communication network 10 comprises a mobile switching center (MSC) 12, a packet data serving node (PDSN) 14, a plurality of base stations 16-i and a plurality of mobile stations 18-k, where i=1,2, . . . n and k=1,2, . . . m. MSC 12, PDSN 14, base stations 14-i and mobile stations 16-k are well-known in the art. Mobile stations 16-k being equipped to receive voice and data services.

Wireless communication network 10 incorporates a well-known multiple access technique, such as Code Division Multiple Access (CDMA). When a customer wants to establish a packet data session, the customer causes mobile station 18-k to send a request, such as an Origination Message, to MSC 12 via base station 14-i for data services. Assuming that the customer has a subscription for data services and is equipped with a mobile station capable of receiving data services, MSC 12 sets up network resources for a packet data session with mobile station 18-k, i.e., a radio connection is established with mobile station 18-k. MSC 12 also sends a request to PDSN 14 to set up a Point-to-Point Protocol (PPP) connection with mobile station 18-k. PDSN 14 subsequently sets up the PPP connection with mobile station 18-k using the network resources set up by MSC 12 and begins the packet data session.

When mobile station 18-k is in an active packet data session, a call termination request (for a voice call) to that mobile station 18-k may be handled by MSC 12 in a variety of manners. The present invention is a Voice call Precedence Over Packet Data (VPOPD) technique which would allow a customer of a wireless communication network service provider to choose whether to receive an incoming call, such as a voice call, during an active packet data session. The VPOPD technique is incorporated as a call processing feature. In one embodiment, this call processing feature uses a single VPOPD value to indicate whether VPOPD is active or inactive. If VPOPD is active, interruption of a packet data session is permitted so that a customer may decide whether to receive an incoming call. If VPOPD is inactive, interruption of a packet data session is not permitted. In another embodiment, the call processing feature uses multiple VPOPD values to indicate whether VPOPD is active or inactive on a per call basis or for all subsequent calls. For ease of discussion, the present invention will be described herein with respect to a single VPOPD value associated with a mobile station. This should not be construed to limit the present invention in any manner.

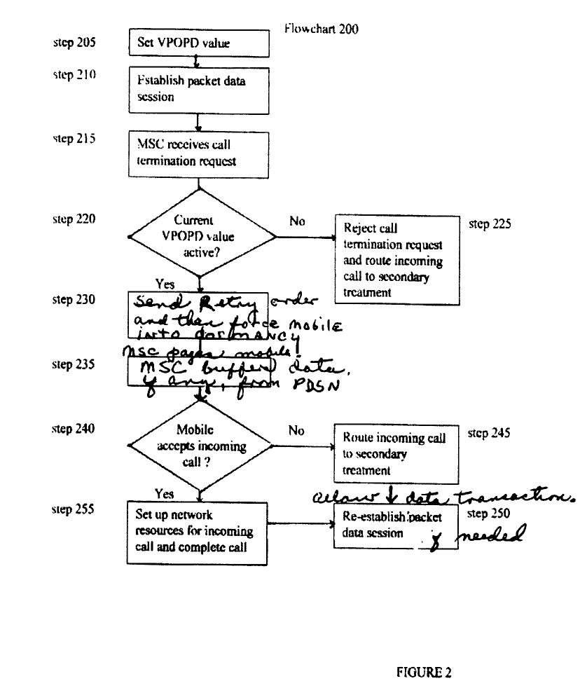

FIG. 2 depicts a flowchart 200 illustrating the VPOPD technique in accordance with one embodiment of the present invention. In step 205, before establishing a packet data session, customer k makes a decision whether to activate or deactivate VPOPD. Upon making this decision, customer k may enter a VPOPD feature code, e.g., *XY, into mobile station 18-k, wherein the VPOPD feature code indicates to MSC 12 a manner of setting the VPOPD value associated with mobile station 18-k. In one embodiment, an VPOPD value of 1 and 0 will be used to indicate whether VPOPD is active or inactive, respectively. Whether an VPOPD feature code is entered into mobile station 18-k by customer k depends on a variety of factors, such as the current VPOPD value, whether the current VPOPD value is to be changed for one call or all calls or some calls, etc. In one embodiment, an VPOPD feature code will only be entered into mobile station 18-k if customer k desires to change the current VPOPD value. If an VPOPD feature code is entered, mobile station 18-k transmits the VPOPD feature code to MSC 12, which uses the VPOPD feature code to set the VPOPD value associated with mobile station 18-k. For example, MSC 12 may cause the VPOPD value for mobile station 18-k in a Home Location Register (HLR) and/or Visitor Location Register (VLR) and/or some other register or database to be set or changed according to the VPOPD feature code.

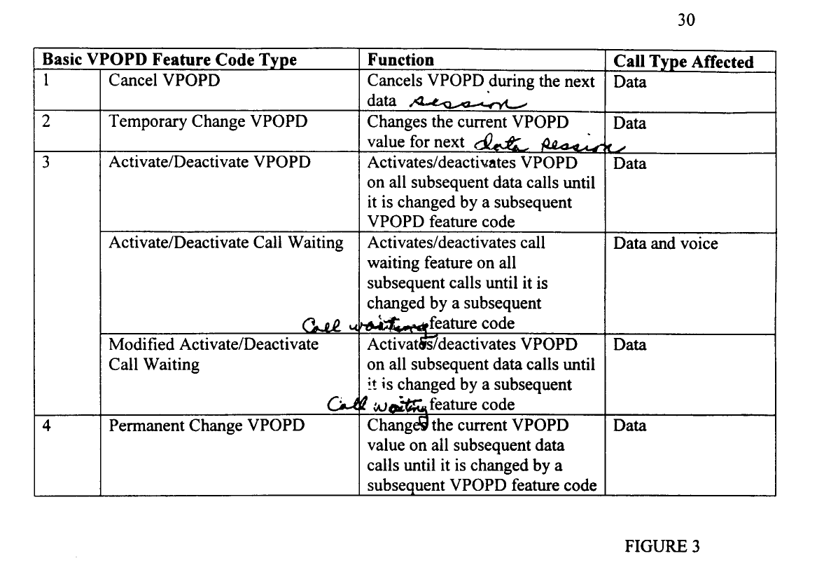

FIG. 3 depicts a table 30 illustrating four basic types of VPOPD feature codes. These four basic types of VPOPD feature codes will be described herein. The first VPOPD feature code indicates to MSC 12 to cancel VPOPD or set the VPOPD value to 0 for mobile station 18-k on a per call basis. The first VPOPD feature code can be a Cancel VPOPD feature code (This feature code may be different than Activate/Deactivate feature code). The Cancel VPOPD feature code indicates to MSC 12 to deactivate VPOPD for mobile station 18-k during the next packet data session in which mobile station 18-k is engaged. Upon completion of the call, VPOPD for mobile station 18-k will automatically be re-activated.

The second VPOPD feature code indicates to MSC 12 to change the current VPOPD value for mobile station 18-k on a per call basis. The second VPOPD feature may also be referred to herein as a Temporary Change VPOPD feature code. Unlike the first VPOPD feature code where VPOPD is deactivated for the next call, the Temporary Change VPOPD feature code changes the current VPOPD value from 1 to 0, or vice-versa, for the next call. That is, the Temporary Change VPOPD feature code can activate, in addition to deactivate, VPOPD. Upon completion of the call, the VPOPD value for mobile station 18-k will automatically be changed back to its previous value.

The third VPOPD feature code indicates to MSC 12 to activate or deactivate VPOPD or set the VPOPD value to 1 or 0 for mobile station 18-k on all subsequent packet data sessions until it is changed by a subsequent VPOPD feature code. The third VPOPD feature code can be an Activate/Deactivate VPOPD feature code. The Activate/Deactivate VPOPD feature code includes a first Activate/Deactivate VPOPD feature code and a second Activate/Deactivate VPOPD feature code. The first Activate/Deactivate VPOPD feature code indicates to MSC 12 to activate VPOPD for mobile-station 18-k on all subsequent packet data sessions until it is changed by a subsequent VPOPD feature code. By contrast, the second Activate/Deactivate VPOPD feature code indicates to MSC 12 to deactivate VPOPD for mobile-station 18-k on all subsequent packet data sessions until it is changed by a subsequent VPOPD feature code.

If the Activate/Deactivate VPOPD feature code is not an available feature code in wireless communication network 10, an Activate/Deactivate Call Waiting feature code may be used as the third VPOPD feature code. The Activate/Deactivate Call Waiting feature code indicates to MSC 12 to activate or deactivate a call waiting feature associated with mobile station 18-k on all subsequent calls until it is changed by a subsequent VPOPD feature code. The Activate/Deactivate Call Waiting feature code is described in the well-known IS-41 standard. In one embodiment, the Activate/Deactivate Call Waiting feature code can be modified (hereinafter referred to as “Modified Activate/Deactivate Call Waiting feature code”) such that the Activate/Deactivate Call Waiting feature code indicates to MSC 12 to activate or deactivate the call waiting feature with respect to packet data sessions only. That is, the Modified Activate/Deactivate Call Waiting feature code is functionally equivalent to the Activate/Deactivate VPOPD feature code. The difference between the Modified Activate/Deactivate Call Waiting feature code and the Activate/Deactivate VPOPD feature code is the actual code being entered into mobile station 18-k, wherein the Modified Activate/Deactivate Call Waiting feature code corresponds to the Activate/Deactivate Call Waiting feature code specified in the IS-41 standard and the Activate/Deactivate VPOPD feature code do not correspond to the Activate/Deactivate Call Waiting feature code specified in the IS-41 standard. Note that in these two instances (where Activate/Deactivate Call Waiting and Modified Activate/Deactivate Call Waiting feature codes are used), the value associated with activating/deactivating the call waiting feature is used as the VPOPD value.

The fourth VPOPD feature code indicates to MSC 12 to change the current VPOPD value for mobile station 18-k on all subsequent packet data sessions until it is changed by a subsequent VPOPD feature code (changes the current value from 1 to 0 or vice versa). The fourth VPOPD feature may also be referred to herein as a Permanent Change VPOPD feature code.

It should be understood that VPOPD feature codes, other than the above described four basic VPOPD feature codes, are possible. The VPOPD feature code may change or activate/deactivate the current VPOPD value for a certain number of packet data sessions, days, hours, etc. Thus, the present invention should not be limited to the VPOPD feature codes described herein.

Returning to flowchart 200, in step 210, mobile station 18-k establishes a packet data session with PDSN 14 using network resources set up by MSC 12. In step 215, MSC 12 receives a call termination request for mobile station 18-k, wherein the call termination request is a message indicating that mobile station 18-k has an incoming call. In step 220, MSC 12 checks the current VPOPD value for mobile station 18-k. If the current VPOPD value is set to 0 (indicating that VPOPD is inactive), in step 225, MSC 12 rejects the call termination request and the incoming call is routed to an existing secondary treatment, such as call forwarding, voice mail service, announcement, etc. If the current VPOPD value is set to 1 (indicating that VPOPD is active), in step 230, MSC 12 forces or causes mobile station 18-k to enter into a dormant state by releasing the network resources being used by mobile station 18-k. Additionally, MSC 12 may send a Stop Record message to PDSN 14 indicating to PDSN 14 that the active packet data call has ended.

Once mobile station 18-k is in the dormant state, MSC 12 can page mobile station 18-k with the call termination request. Between the time mobile station 18-k is forced or caused to enter into the dormant state and the time MSC 12 pages mobile station 18-k, mobile station 18-k might perform an action that would prevent MSC 12 from successfully paging mobile station 18-k. For example, mobile station 18-k may attempt to re-establish packet data session during race condition. This time period during which mobile station 18-k may perform an action that would prevent MSC 12 from successfully paging mobile station 18-k is referred to herein as a “race condition”.

Race conditions are undesirable. In the present invention, race conditions are prevented such that MSC 12 can successfully page mobile station 18-k with the call termination request. Specifically, in order to prevent race conditions, MSC 12 sends a Prevent Race Condition message to mobile station 18-k prior to forcing or causing mobile station 18-k to enter into a dormant state, wherein the Prevent Race Condition message is a message indicating to mobile station 18-k not to perform an action that would prevent MSC 12 from successfully paging mobile station 18-k. In one embodiment, the Prevent Race Condition message is a Retry Order which indicates to mobile station 18-k not to try re-establishing the packet data session for a predetermined time period.

In step 235, MSC 12 pages mobile station 18-k using standard call termination treatment, such as displaying the calling number at mobile station 18-k (if available). In step 240, mobile station 18-k receives the page and customer k decides whether to accept or reject the incoming call, for example, by answering or not answering the page. If the incoming call is rejected, in step 245, the incoming call is routed to secondary treatment. From step 245, flowchart 200 continues to step 250. In step 250, MSC 12 re-establishes the packet data session with mobile station 18-k. In particular, MSC 12 sets up network resources to used by mobile station 18-k and sends a Start Record message to PDSN 14 indicating to PDSN 14 the start of a packet data call (continuing the packet data session),

If the incoming call is accepted, in step 255, MSC 12 sets up network resources for the incoming call with mobile station 18-k. Upon termination of the call, flowchart 200 continues to step 250 where MSC 12 re-establishes the packet data session with mobile station 18-k.

Although the present invention has been described herein with respect to certain embodiments, other embodiments are possible. For example, the VPOPD value may also be changed by the service provider of the wireless communication network, or the VPOPD value may also be changed during an active call. Therefore, the present invention should not be construed to be limited to the embodiments disclosed herein.

We claim:

1. A method of call processing comprising the steps of:
setting a feature value to be used in call processing when an associated mobile station has an active packet data session; and
determining whether to reject a call termination request for the mobile station when the mobile station has an active packet data session using the feature value.

2. The method of claim 1, wherein the feature value is not used in determining whether to reject a call termination request for the mobile station when the mobile station is in a voice call.

3. The method of claim 1, wherein the step of setting the feature value comprises the step of:
receiving a feature code from the mobile station indicating a manner of setting the feature value.

4. The method of claim 3, wherein the feature code indicates to set the feature value to reject call termination requests during a next packet data session.

5. The method of claim 3, wherein the feature code indicates to change the feature value at which the feature value is currently during a next packet data session.

6. The method of claim 3, wherein the feature code indicates to set the feature value to reject call termination requests during all subsequent packet data sessions or to accept call termination requests during all subsequent packet data sessions.

7. The method of claim 3, wherein the feature code indicates to set the feature value to reject call termination requests during all subsequent calls or to accept call termination requests during all subsequent calls.

8. The method of claim 7, wherein the feature code is an Activate/Deactivate Call Waiting feature code.

9. The method of claim 8, wherein the feature value set using the Activate/Deactivate Call Waiting feature code is used in determining whether to reject a call termination request for the mobile station only when the mobile station is in a packet data session.

10. The method of claim 3, wherein the feature code indicates to change the feature value at which the feature value is currently during all subsequent packet data sessions.

11. The method of claim 1, wherein the step of setting the feature value comprises the step of:
updating a database entry for the mobile station using the feature value, wherein the updated database entry is used to determine whether to reject a call termination request for the mobile station.

12. The method of claim 11, wherein the database entry being updated is an entry in a Home Location Register or Visitor Location Register.

13. The method of claim 1 comprising the additional steps of:
causing the mobile station to enter a dormant state if the call termination request is not rejected;
paging the mobile station of an incoming call associated with the call termination request.

14. A method of call processing comprising the steps of:
receiving a call termination request for a mobile station in an active packet data session;
sending a message to the mobile station to prevent race conditions;
causing the mobile station to enter a dormant state; and
paging the mobile station of an incoming call associated with the call termination request.

15. The method of claim 14, wherein the message is a Retry Order message.

16. The method of claim 14, wherein the active call is an active packet data session.

17. The method of claim 14, wherein the step of causing the mobile station to enter the dormant state comprises the step of:
releasing network resources being used by the mobile station for the active packet data session.

18. The method of claim 14 comprising the additional step of:
re-establishing a packet data session with the mobile station after rejection of the incoming call or completion of the incoming call.

19. The method of claim 18, wherein the step of re-establishing the packet data session comprises the steps of:
setting up network resources for the packet data session; and
sending a message to start packet data session.

20. A method of call processing comprising the steps of:
transmitting a feature code to indicate a manner of setting a feature value to be used in call processing when an associated mobile station is in a packet data session; and
establishing a packet data session.
